(19) United States
(12) Patent Application Publication
(10) Pub. No.: US 2007/0039745 A1
(43) Pub. Date: Feb. 22, 2007

(54) Wireless subsoil sensor network

(75) Inventors: Noel Wayne Anderson, Fargo, ND (US); Stephen Michael Faivre, Kingston, IL (US); Mark William Stelford, Sycamore, IL (US)

Correspondence Address: DEERE & COMPANY, ONE JOHN DEERE PLACE, MOLINE, IL, 61265, US

(73) Assignee: Deere & Company, a Delaware corporation

(21) Appl. No.: 11/206,600

(22) Filed: Aug. 18, 2005

(51) Int. Cl. A01B 63/00

(52) U.S. Cl. 172/6; 137/78.3

(57) ABSTRACT

A sensor network comprising one or more passive sensors dispersed within a soil at known coordinate locations and depths. A transceiver wirelessly communicates with the passive sensors to receive data indicating a condition within the soil, such as environmental condition or a biological presence. The wireless communication is performed on a radio frequency suitable for transmission through soil. The transceiver may be attached to a vehicle located above or below the surface of the soil, a device engaging the soil, or an active sensor located within the soil.

### FIELD OF THE INVENTION

The present invention relates to soil sensors, and more specifically wirelessly communicating subsoil sensor networks.

### BACKGROUND OF THE INVENTION

Water that falls as rain or is applied through irrigation to a field, and things that dissolve in it such as nitrogen fertilizers, can go to one of five places: evaporate (water) into the atmosphere; taken up and stored in a plant (ignored is any water that might be consumed by an animal from a puddle); stored in the soil; flow off the field or through a tile system to become surface water in a pond, stream, ditch, etc; seep down into a water table.

Accurate modeling of the flow of water from its source to one of the above five fates is essential for crop, soil, and water management that uses models. Also important for high fidelity crop and soil modeling are factors that include, but are not limited to, soil temperature and nutrients. In the past, lack of economical sensing and processing means has limited the fidelity and economics of models for use in production agriculture. The data is required to initialize and maintain models. Even more critical to the long term success of crop and soil models is the ability to compare predictions with measurements so that the model can learn or adapt to improve its prediction accuracy over time.

Published work to date has focused on surface networks where the transmitting means is at the surface or above ground. High fidelity soil and crop modeling will require high density, economical data collection at depths of four feet or more that cover the root zone wherein plant root systems can collect moisture and nutrients. What is needed is high density, economical data collection of surface and subsurface sensors.

### SUMMARY OF THE INVENTION

The present invention described herein is a network of heterogeneous sensors that may economically enable high fidelity crop and soil modeling. For description of this invention, the soil is split into four zones: surface, root zone (tilled), root zone (sub-tilled), and sub-root zone. A first class of long-lived passive sensors is deployed to the root zone (sub-tilled) and the sub-root zone. A second class of short-lived passive sensors is deployed on the surface or in the root zone where tillage could take its toll. And a third class of active sensors, fewer in number than passive sensors, are deployed throughout the soil.

The active sensors have a first transceiver communicating above ground, and a second transceiver communicating with the passive subsurface sensors. Subsurface passive sensors unable to communicate with a second transceiver may be energized and read by a mobile transceiver on a passing vehicle such as a tractor, combine, or scouting robot. Deeply buried passive sensors may be energized and read by a mobile transceiver on a robot adapted to travel through tile lines, or mounted on a ground engaging device that is moved through the tilled root zone.

### BRIEF DESCRIPTION OF THE DRAWINGS

FIG. 1 illustrates a network of heterogeneous soil sensors and a first embodiment for communication with the sensors.

FIG. 2 illustrates a network of heterogeneous soil sensors and a second embodiment for communication with the sensors.

FIG. 3 illustrates a network of heterogeneous soil sensors and a third embodiment for communication with the sensors.

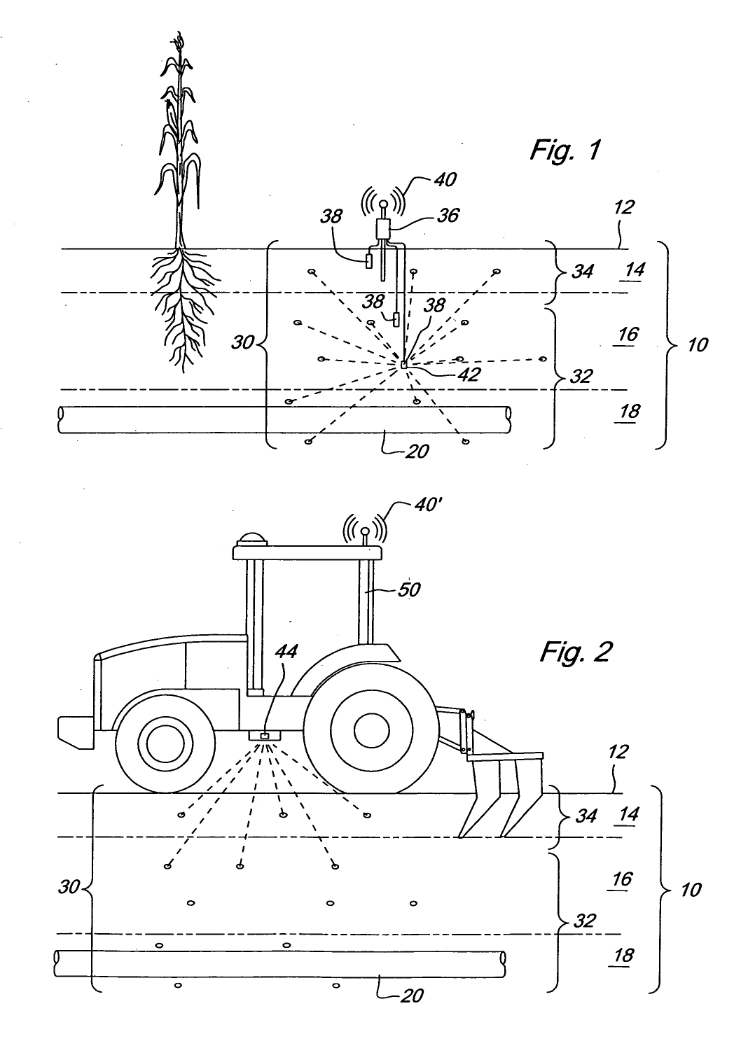

FIG. 1 illustrates a network of heterogeneous soil sensors and a fourth embodiment for communication with the sensors.

### DETAILED DESCRIPTION

For description of this invention, the soil 10 is split into four zones: surface 12, root zone (tilled) 14, root zone (sub-tilled) 16, and sub-root zone 18. The boundaries of these zones will vary from year to year based on the crop grown and the tillage practice for that year. All four soil zones are critical for modeling soils and crops since mechanical forces, water, and nutrients are applied to them at various points and sometimes change because of the system inputs. Another subsurface factor is drainage tile 20 which may be placed into the lower two zones and is a major factor in what happens to water and nutrients at those levels.

To be useful for high fidelity modeling, soil data must come from sensors that are localized in space and time, have suitable precision and accuracy of the attributes they measure, and have data which can be collected at suitable temporal and spatial resolution. The sensor network 30 must do these things economically so the data can have a profitable impact on crop production. The present invention described herein is a network of heterogeneous sensors 30 that may economically enable high fidelity crop and soil modeling. The type of data collected by these sensors may include, but is not limited to, environmental conditions and the presence of biological material.

The first class of sensors to be discussed is long-lived passive sensors 32. Examples of such sensors known in the art include, but are not limited to, RFID sensors adapted to measure specific attributes. These sensors would be deployed at known locations within the root zone (sub-tilled) 16 and the sub-root zone 18. Because of the depth of these zones, it is more expensive to locate sensors there. Passive sensors, because they contain no battery, could be designed and constructed to last for decades before needing to be replaced. Deployment costs could be reduced by putting them in at the same time as tile 20 with some located above and some located below the tile line 20. Otherwise a human or a robot would need to go through a field and deploy the sensors 30, noting sensor ID, latitude, longitude, and depth. The deployment would also need to be done with minimal invasiveness so the soil profile above the sensor remains representative of the area.

The second class of sensors to be discussed is short-lived passive sensors 34. These are similar to the first class except they are made to be disposable and lower cost, perhaps operating a season or two before succumbing to the elements. These would be deployed at known locations on the surface 12 or in the root zone 14 where tillage could take its toll. This class may also include other examples known in the art, such as recently developed MEMs and nanotechnology sensors which could be very inexpensive. Since the goal of this invention is to have a 3D sensor network, the fact that these particles might migrate in the soil profile as a result of heavy rains or tillage may make them less desirable than a larger sensor due to loss of depth information.

The third class of sensors to be discussed is active sensors 36. These sensors are widely known in the art, and may have a probe 38 that goes several feet into the soil and can report data from multiple depths. These sensors have a battery, ultra-capacitor, fuel cell, etc. on board which enables significantly more data collection, processing, and communication than passive sensors 32, 34. This class of sensors is commercially available except for one feature to be described later. The cost of the sensor 36 and service life limited by the energy source direct the design of this class to be units that can be deployed to the field, recovered for battery replacement, and then redeployed. Because of the cost of these sensors 36 and the need to retrieve them to replace energy sources, they will be fewer in number than passive sensors 32, 34.

Commercial active sensors 36 and probes 38 are now being enabled with wireless communications 40 means to transmit data to a second location. The frequencies and protocols used are those generally used for wireless modems, cell phones, Bluetooth, wireless Ethernet and the like. A novel feature disclosed here is a second transmitter/receiver 42 located at the lowest point of the sensor 36 or probe 38. The frequencies and protocols used by this second transceiver 42 would be optimized for subsurface communications with buried passive sensors 32, 34. One choice of frequencies and protocols would be those used already in use for RFID tags. Research has been done, particularly by the US Department of Defense, on long range, low power subsurface radio communications. Thus frequencies and protocols different from those used for above ground communications may be preferred for communication with the second transceiver 42.

FIG. 1 shows the four soil zones with an active probe 36 having a first transceiver 40 that communicates with an above ground frequency and protocol and a second transceiver 42 that communicates with passive subsurface sensors 32, 34 with a subsurface frequency and protocol. The signal from 42 is used to power the passive sensors data collection, processing, and transmission as for commercially available RFID sensors. Data is collected from passive sensors 32, 34 via second transceiver 42 and transmitted to a second location using first transceiver 40. The second location may ultimately be a first hop on a phone or internet transmission that can literally relay the data to any place on earth.

If a first transceiver 40 has limited range preventing it from communicating with a second fixed location, then a passing vehicle 50 may be used to implement a store-and-forward network. Likewise, subsurface passive sensors 32, 34 unable to communicate with a second transceiver 42 may be energized and read by a mobile transceiver 44 on a passing vehicle 50 such as a tractor, combine, or scouting robot as shown in FIG. 2. Data from the sensors can be relayed wirelessly 40′ from the vehicle 50 to a second fixed location, or alternately may be captured in a storage device and removed from the vehicle 50 for delivery to a second fixed location. The passing vehicle 50 can also provide space and time localization of the sensor reading using a means such as GPS.

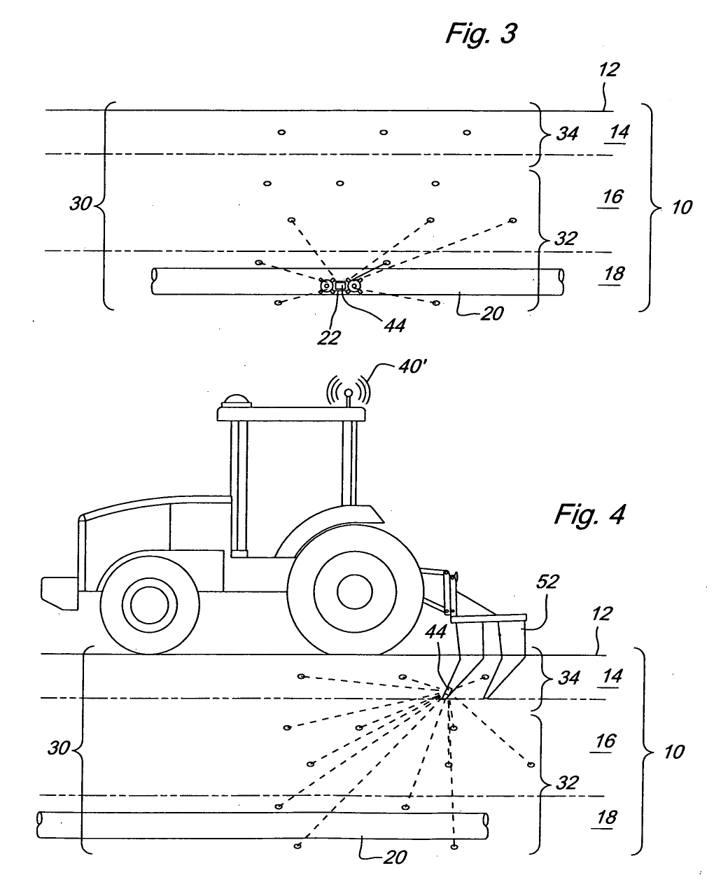

Passive sensors 32 buried deep in the soil may be unable to communicate with a second transceiver 42 or a mobile transceiver 44 on the surface. Water, minerals, low signal strength, and distance can combine to prevent communication. Deeply buried passive sensors 32 may be energized and read by a mobile transceiver 44 on a robot 22 adapted to travel through tile lines 20 as another means of getting a transceiver closer to a sensor, as shown in FIG. 3. The mobile transceiver 44 could also be mounted on a ground engaging device 52 that is moved through the tilled root zone 14 as shown in FIG. 4. The disadvantage would be that the ground engaging device 52 may damage sensors 34 on the surface 12 or in the tillage root zone 14. If controlled traffic is being practiced, the sensors 34 could be placed in the soil to avoid collisions.

Having described the preferred embodiment, it will become apparent that various modifications can be made without departing from the scope of the invention as defined in the accompanying claims.

### ASSIGNMENT

The entire right, title and interest in and to this application and all subject matter disclosed and/or claimed therein, including any and all divisions, continuations, reissues, etc., thereof are, effective as of the date of execution of this application, assigned, transferred, sold and set over by the applicant(s) named herein to Deere & Company, a Delaware corporation having offices at Moline, Ill. 61265, U.S.A., together with all rights to file, and to claim priorities in connection with, corresponding patent applications in any and all foreign countries in the name of Deere & Company or otherwise.

1. A sensor network comprising one or more passive sensors, and a transceiver in wireless communication with at least one sensor, the sensors being dispersed within a composite material and having known positions.

2. The sensor network described in claim 1 wherein the composite material is a soil, and the position of each sensor is defined by a coordinate location and a depth.

3. The sensor network described in claim 2 wherein the wireless communication being performed on a radio frequency suitable for transmission through soil.

4. The sensor network in claim 1, 2, or 3 wherein the sensor is a RFID, MEMs, or nanotechnology sensor, indicating a condition within the composite material.

5. The sensor network described in claim 4 wherein the condition sensed is an environmental condition or a biological presence.

6. The sensor network described in claim 1, 2, or 3 wherein the transceiver attaching to a vehicle located above the surface of the composite material.

7. The sensor network described in claim 1, 2, or 3 wherein the transceiver attaching to a vehicle located below the surface of the composite material.

8. The sensor network described in claim 1, 2 or 3 wherein the transceiver attaching to a device engaging the composite material.

9. The sensor network described in claim 1, 2, or 3 wherein the transceiver attaching to an active sensor located within the composite material.

10. A sensor network comprising one or more passive sensors, and a transceiver in wireless communication with at least one sensor, the sensors being dispersed within a soil, each sensor having a known coordinate location and a depth, each sensor indicating a condition within the soil, the wireless communication being performed on a radio frequency suitable for transmission through soil.

11. The sensor network described in claim 10 wherein the condition sensed is an environmental condition or a biological presence.

12. The sensor network described in claim 10 or 11 wherein the transceiver attaching to a vehicle located above the surface of the soil.

13. The sensor network described in claim 10 or 11 wherein the transceiver attaching to a vehicle located below the surface of the soil.

14. The sensor network described in claim 10 or 11 wherein the transceiver attaching to a device engaging the soil.

15. The sensor network described in claim 10 or 11 wherein the transceiver attaching to an active sensor located within the soil.

16. A sensor network comprising one or more passive sensors, at least one active sensor having a transceiver in wireless communication with at least one passive sensor, the sensors being dispersed within a soil, each sensor having a known coordinate location and a depth, each sensor indicating a condition within the soil.

17. The sensor network described in claim 16 wherein at least one passive sensor is located in a sub-tillage zone, and at least one passive sensor is located in a tillage zone or a surface zone.

18. The sensor network described in claim 16 wherein at least one passive sensor is located in a sub-tillage sub-root zone, at least one passive sensor is located in a sub-tillage root zone, and at least one passive sensor is located in a tillage zone or a surface zone.

19. The sensor network in claim 16, 17, or 18 wherein the passive sensor is a RFID, MEMs, or nanotechnology sensor.

20. The sensor network described in claim 19 wherein the condition sensed is an environmental condition or a biological presence.
